(19) United States
(12) Patent Application Publication
(10) Pub. No.: US 2009/0236352 A1
(43) Pub. Date: Sep. 24, 2009

(54) Handle for Baking Device

(76) Inventors: Lifeng Xie, (US); Xinbiao Fu, (US)

Correspondence Address: KENING LI;PINSENT MASONS LLP, c/o FOUNTAIN LAW GROUP, INC, 18201 Von Karman Avenue, Suite 960, Irvine, CA, 92612, US

(21) Appl. No.: 12/406,131

(22) Filed: Mar. 18, 2009

(30) Foreign Application Priority Data
Mar. 18, 2008 (CN) 200820101727.9

(51) Int. Cl. A47J 45/06

(52) U.S. Cl. 220/756; 220/573.1; 220/755; 220/764; 220/769

(57) ABSTRACT

A bakeware handle comprises a raised part fixedly connected to one side of the bakeware and extending outwards, and the raised ear has a short shaft; a main body of bakeware handle whose tongue part extends to the bakeware being pin jointed with the short shaft; at least a torsional spring covering the short shaft; one end of the torsional spring is set against the raised ear and the other end of the torsional spring is set against the main body of bakeware handle. In the immovable state of the main body of bakeware handle, the tongue part of the main body of bakeware handle is locked at the same edge of the shell that disposed on the bakeware of the electrical baking device. The bakeware is locked at the shell by the pretightening force of the torsional spring. When the main body of bakeware handle is turned relative to the short shaft, the torsional spring is compressed, and the tongue part of the main body of bakeware handle gets separated from the same edge of the shell that disposed on the bakeware of the electrical baking device, and the bakeware is taken away form the shell of the electrical baking device.

### CROSS REFERENCES TO RELATED APPLICATIONS

This application claims priority to People's Republic of China Patent Application No.: 200820101727.9, filed on Mar. 18, 2008, the entire disclosure of which is incorporated herein by reference.

### FIELD OF THE INVENTION

The present invention relates to an electrical baking device.

### RELATED ART

In known electrical baking device, a metal reflecting board is set at the open end side of the insulating shell, an open window is provided in the middle of the reflecting board, a metal heat-conduction plate is provided in the window, wherein the heat-conduction plate, the reflecting board and the shell together form a closed room, and an electrical heating tube is fixedly connected to the heat-conduction plate.

There is bakeware on the outer surface of the heating-conduction plate separately. The upper surface of the bakeware is baking side. In washing the bakeware, the bakeware is taken away from the heating-conducting plate of the shell. There are two extending handles at two sides of the bakeware for people holding the bakeware. If the bakeware can not be fixed on the heat-conducting plate, the bakeware will shake to affect its working even the bakeware is laid on the heat-conducting plate of the shell. So a locking hook pushed by a transverse spring is set at each bakeware handle, and the bakeware is fixed on the heat-conducting plate by the locking hook locking the edge of the shell. In this way, when the bakeware is needed to be taken away from the heat-conducting plate of the shell, the connecting piece of the locking hook is pushed to compress the spring to make the locking hook being separated from the shell. When the bakeware is needed to being fixed on the heat-conducting plate of the shell, releasing the connecting piece of the locking hook, the locking hook locks the shell at the restoring force of the spring. Above structure can overcome the problem of the connecting of the bakeware and the heat-conducting plate, but it also has disadvantageous as follows: there are oriented and position group of locking hook at the handle, which has a complicated structure, has a high production cost.

### SUMMARY OF THE INVENTION

The present invention provides a bakeware handle, which has the function of handle and locking hook, is used conveniently, and has a low production cost.

The present invention adopts technical means as follows: a bakeware handle, comprising a raised part fixedly connected to one side of the bakeware and extending outwards, and the raised ear has a short shaft; a main body of bakeware handle whose tongue part extends to the bakeware being pin jointed with the short shaft; at least a torsional spring covering the short shaft; one end of the torsional spring is set against the raised ear and the other end of the torsional spring is set against the main body of bakeware handle. In the immovable state of the main body of bakeware handle, the tongue part of the main body of bakeware handle is locked at the same edge of the shell that disposed on the bakeware of the electrical baking device. The bakeware is locked at the shell by the pretightening force of the torsional spring. When the main body of bakeware handle is turned relative to the short shaft, the torsional spring is compressed, and the tongue part of the main body of bakeware handle gets separated from the same edge of the shell that disposed on the bakeware of the electrical baking device, and the bakeware is taken away form the shell 8 of the electrical baking device.

In the preferred embodiment, two ends of the short shaft respectively have a torsional spring, and one end of each torsional spring is set against the raised ear and the other end of the torsional spring is set against the main body of bakeware handle, which can increase the torsional force evenly.

A preferred main body of bakeware handle is as follows: the lower part of the main body of bakeware handle has an inward hollow part formed by a border side and a baffle side, and the middle part of the baffle side has a position giving-up opening; the nether surface of the inward hollow part has two raised parts that extend downwards, and the two raised parts are respectively set at two sides of position giving-up opening of the baffle side; the raised ear is inserted into the inward hollow of the main body of bakeware handle from the position giving-up groove of the baffle side of the main body of bakeware handle, and the two ends of the short shaft of the raised ear are pin jointed with the two raised parts. The main body of bakeware handle can be once formed by pressure injection-mould.

Further, an inner cover board is installed under the main body of bakeware handle to cover the inward hollow; the upper surface of the inner cover board has two raised parts that extend upwards; each raised part is corresponding with each raised part that extend downwards of the inward hollow of the main body of bakeware handle. There are semicircle grooves at the opposite sides of the two raised parts of the inner cover plate and the two raised parts of the main body of bakeware handle to form pin jointed holes of the two ends of the short shaft of the raised ear. Increasing an inner cover board can improve the appearance of the handle and is convenient for washing. There are semicircle grooves at their opposite sides of the two raised parts of the inner cover plate and the two raised parts of the main body of bakeware handle, and the semicircle grooves form pin jointed holes for the two ends of the short shaft of the raised ear of the bakeware, which can be once-formed by pressure injection-mould and reduce a working procedure of drilling.

Further, each raised part of the inner cover board has a through hole, and each raised part of the main body of bakeware handle has a bolt hole corresponding with above through hole at the outer side of the semicircle grooves; the two bolts drill through the two through holes of the inner cover board to get into the two bolt holes of the main body of bakeware handle. The structure is also once formed by pressure injection-mould. The inner cover board is fixed to the main body of bakeware handle, which assembled easily.

The main body of the present bakeware handle whose tongue part extending to the bakeware is pin jointed with the short shaft of the raised ear of the side of the bakeware; the torsional spring covering the short shaft is set against the raised part and the main body of bakeware handle. The main body of bakeware handle has two position state relative to the short shaft of the raised ear, and its tongue part locks or gets separated from the shell of the electrical baking device, to come true its function of handle and locking hook. The main body of bakeware handle locks and gets separated from the shell of the electrical baking device just by a turning movement, which is simple and very fit for singlehanded action. The main body of bakeware handle and the inner cover board can be once formed by pressure injection-mould. The bakeware handle of the present invention has a simple structure, is machininged easily, can reduce the production cost greatly. There are semicircle grooves at their opposite sides of the two raised parts of the inner cover plate and the two raised parts of the main body of bakeware handle, and the semicircle grooves form pin jointed holes for the two ends of the short shaft of the raised ear of the bakeware. At the same time of fixing the inner cover board on the main body of bakeware handle by bolts, the main body of bakeware handle is pin jointed with the short shaft of the raised part, which is assembled easily and rapidly.

### BRIEF DESCRIPTION OF THE DRAWINGS

FIG. 1 is the sketch map of the expanding structure of one embodiment of a bakeware that adopts the bakeware handle of the present invention.

FIG. 2 is the sketch map of the state that the inner cover board is installed in the embodiment of FIG. 1.

FIG. 3 is the cutaway view of the state that the bakeware handle is locked on the shell of the electrical baking device in the embodiment of FIG. 1.

FIG. 4 is the cutaway view of the state that the bakeware handle is released from the shell of the electrical baking device in the embodiment of FIG. 1.

### DETAILED DESCRIPTION OF THE PREFERRED EMBODIMENTS

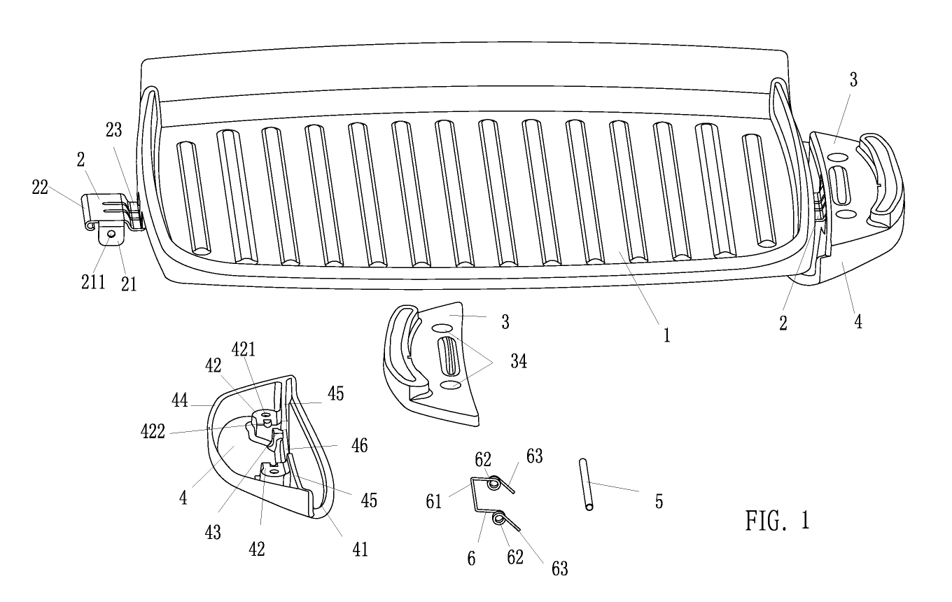

FIG. 1 is the structure of a bakeware 1 that adopts the bakeware handle of the present invention, and the bakeware 1 is set on the upside of double-faced electrical baking device with an upper shell. The bakeware is approximately rectangular and is founded by aluminum alloy. The nether surface (the surface with arris in FIG. 1) of the bakeware 1 is a baking side, and the upper surface of the bakeware 1 is a plane that is connected to the heat-conduction plate disposed on the upper shell of the electrical baking device. The left side and the right side of the bakeware 1 respectively have bakeware handles that are convenient for holding and moving the bakeware 1, and the bakeware 1 can be locked on the upper shell of the electrical baking device.

In the expanding structure of the left bakeware handle of the bakeware 1 in FIG. 1, the bakeware handle is composed of a raised ear 2, an inner cover board 3, a main body 4 of bakeware handle, a short shaft 5 and a torsional spring 6.

The raised ear 2 is struck out by iron piece and is fixedly connected to one side of the bakeware 1 by bolts and extends outwards. Two side flanks 21 of the raised part 2 respectively have shaft holes 211, and the flanks 21 bend upwards to form a bracket for supporting the short shaft 5. A tongue part 22 of the raised part 2 bends upwards for receiving a common side 61 of the torsional spring 6. The root of the raised part 2 has a hollow 23.

The main body 4 of bakeware handle is once formed by pressure injection-mould. The upside of the main body 4 has a tongue part 41, and its lower part has an inward hollow part formed by a border side 44 and a baffle side 45. The middle part of the baffle side 45 has a position giving-up opening 46. The nether surface of the inward hollow part of the main body 4 of bakeware handle has two raised parts 42 that extend downwards. The two raised parts 42 are respectively set at two sides of position giving-up opening 46, and their side surfaces are integrative with the baffle side 45. The end sides of the two raised parts 42 respectively have bolt holes 421. The two raised parts 42 have semicircle grooves 42 at their opposite sides. There are two baffle poles 43 at inner sides of the two raised parts 42, and the side surfaces of the two baffle poles 43 are integrative with the baffle side 45 too. Lengthways groove for receiving inner ends 63 of the torsional spring 62 is formed between every baffle pole 43 and its adjacent raised part 42.

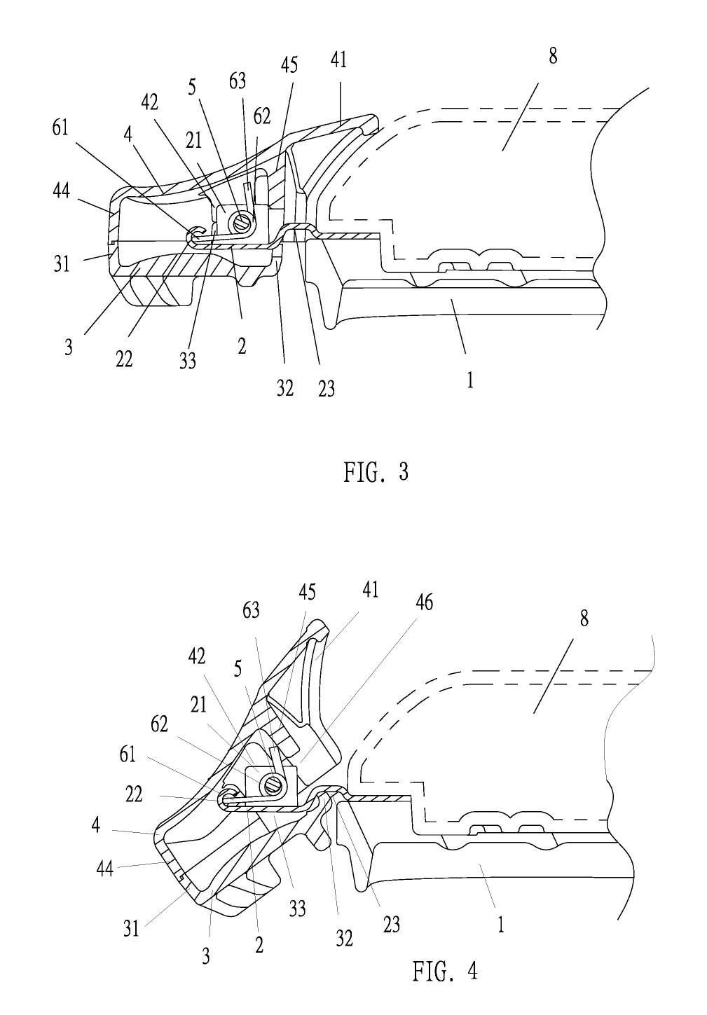

Referring to FIGS. 3 and 4, the inner cover board 3 is once formed by pressure injection-mould, and its upper surface has an inward hollow part formed by a border side 31 and a baffle side 32. The inward hollow is corresponding with the inward hollow of the main body 4 of bakeware handle. The middle part of the baffle 32 has a position giving-up opening for receiving the raised ear 2. The inward hollow of the inner cover board 3 has two raised parts 33 that extend upwards. Each raised part 33 is corresponding with each raised part 42 that extend downwards of the inward hollow of the main body of bakeware handle. Each raised parts 33 of the inner cover board 3 has a through hole 34 matched with the bolt hole 421 of the raised part 42 of the main body of bakeware handle. There are semicircle grooves in the end sides of the two raised parts 33 of the inner cover board 3 in their opposite sides.

The torsional spring 6 can be considered to be made up of two torsional springs. Outer ends of the two torsional springs are integrative by a transverse bar to form a common side 61.

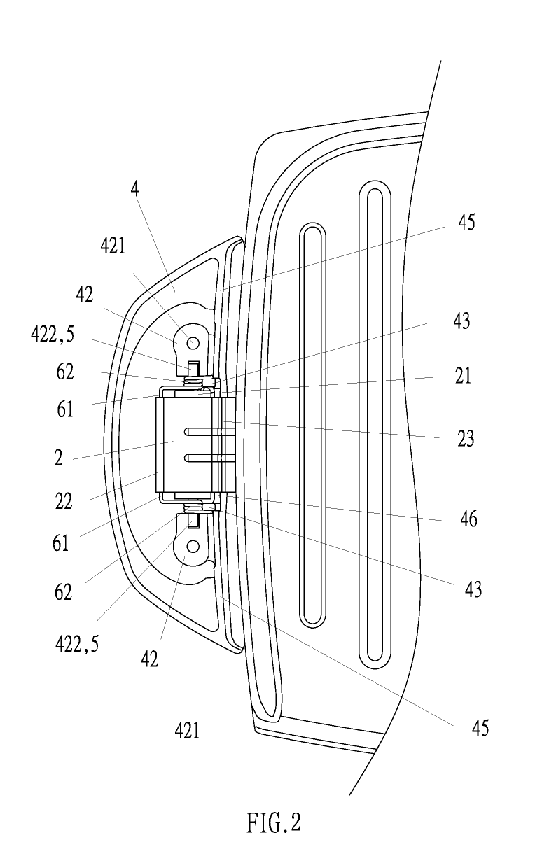

In assembling, the short shaft 5 is inserted into the shaft holes 211 of the two side flanks 21 of the raised ear 2, then the common side 61 of the torsional spring 6 is wedged into the tongue part 22 of the raised ear 2, then the screw bodies 62 of the torsional spring 6 respectively cover two ends of the short shaft 5. The tongue part 41 of the main body 4 of bakeware handle faces the bakeware 1, and the position giving-up groove 46 of the baffle side 45 of the main body 4 of bakeware handle is pointed at the root of the raised part 2 to make the raised part 2 being inserted into the inward hollow of the main body 4 of the bakeware handle from the position giving-up groove 46 of the baffle side 45 of the main body 4 of the bakeware handle. The two inner ends 63 of the torsional spring 6 are respectively inserted into the inward hollow of the main body 4 of bakeware handle and into the lengthways groove between the baffle pole 43 and its adjacent raised part 42, and the two inner ends 63 of the torsional spring 6 is set against the inner wall of the baffle side 45. Referring to FIG. 2, the two ends of the short shaft 5 of the raised ear 2 are respectively posited in the semicircle grooves 422 of the two raised parts 42 of the main body 4 of bakeware handle.

Then the inner cover board 3 is installed under the main body 4 of bakeware handle to cover the inward hollow of the main body 4 of bakeware handle. The border side 31 and the baffle side 32 of the inner cover board 3 are buckled at the border side 44 and the baffle side 45 of the main body 4 of bakeware handle, and the two raised parts 33 of the inner cover board 3 are connected to the two raised parts 42 of the main body 4 of bakeware handle, and the two semicircle grooves of each connecting side form a pivot hole to accept the two ends of the short shaft 5 of the raised ear 2 to make he main body 4 of bakeware handle being pin jointed with the short shaft 5 of the raised part 5. Two bolts drill through the two through holes 34 of the inner cover board 3 to get into the two bolt holes 421 of the main body 4 of bakeware handle. The inner cover board 3 is fixed on the main body 4 of bakeware handle. The assembling of the present invention is very simple.

The right bakeware handle of the bakeware 1 is symmetrical with the left bakeware handle in the structure. There are no more descriptions here.

After the above handles were installed on the bakeware 1, people can hold the two handles to take the bakeware 1 and install the bakeware 1 on the upper shell of the electrical baking device to make the bakeware 1 being against the heat-conduction plate. In washing the bakeware 1, the bakeware 1 is disassembled from the upper shell of the electrical baking device to make the bakeware 1 be separated from the heat-conduction plate of the upper shell of the electrical baking device.

Referring to FIG. 3, it is the structure of the present embodiment locked on the shell of the electrical baking device. The common side 61 of the torsional spring 6 is set against the tongue part 22 of the raised ear 2, and its two outer ends are set against the baffle side 45 of the main body 4 of bakeware handle to make the main body 4 of bakeware handle being immovable. The tongue part 41 of the main body 4 of bakeware handle is locked at the same edge of the shell 8 that disposed on the bakeware 1 of the electrical baking device. The bakeware 1 is locked at the shell 8 by the pretightening force of the torsional spring 6. If the tongue part 41 of the main body 4 of bakeware handle was separated from the shell 8, the elliptoid raised part of the inward hollow of the inner cover board 3 will restrict the range that the tongue part 41 of the main body 4 of bakeware handle turning downwards.

Referring to FIG. 4, it is the state that the tongue part 41 of the main body 4 of bakeware handle separating from the shell 8 of the electrical baking device. The main body 4 of bakeware handle is turned relative to the short shaft 5. The hollow 23 at the root of the raised ear 2 provides a position giving-up space for the baffle side 32 of the inner cover board 3 and restricts the turning range of the main body 4 of bakeware handle. The torsional spring 6 is compressed, and the tongue part 41 of the main body 4 of bakeware handle gets separated from the same edge of the shell 8 that disposed on the bakeware 1 of the electrical baking device, and the bakeware 1 is taken away form the shell 8 of the electrical baking device.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

What is claimed is:

1. A bakeware handle, comprising a raised part fixedly connected to one side of the bakeware and extending outwards, and the raised ear has a short shaft; a main body of bakeware handle whose tongue part extends to the bakeware being pin jointed with the short shaft; at least a torsional spring covering the short shaft; one end of the torsional spring is set against the raised ear and the other end of the torsional spring is set against the main body of bakeware handle.

2. The bakeware handle according to claim 1, wherein two ends of the short shaft respectively have a torsional spring, and one end of each torsional spring is set against the raised ear and the other end of the torsional spring is set against the main body of bakeware handle.

3. The bakeware handle according to claims 1 or 2, wherein the lower part of the main body of bakeware handle has an inward hollow part formed by a border side and a baffle side, and the middle part of the baffle side has a position giving-up opening; the nether surface of the inward hollow part has two raised parts that extend downwards, and the two raised parts are respectively set at two sides of position giving-up opening of the baffle side; the raised ear is inserted into the inward hollow of the main body of bakeware handle from the position giving-up groove of the baffle side of the main body of bakeware handle, and the two ends of the short shaft of the raised ear are pin jointed with the two raised parts.

4. The bakeware handle according to claim 3, wherein an inner cover board is installed under the main body of bakeware handle to cover the inward hollow; the upper surface of the inner cover board has two raised parts that extend upwards; each raised part is corresponding with each raised part that extend downwards of the inward hollow of the main body of bakeware handle; there are semicircle grooves at the opposite sides of the two raised parts of the inner cover plate and the two raised parts of the main body of bakeware handle, and the semicircle grooves form pin jointed holes of the two ends of the short shaft of the raised ear.

5. The bakeware handle according to claim 4, wherein each raised part of the inner cover board has a through hole, and each raised part of the main body of bakeware handle has a bolt hole corresponding with above through hole at the outer side of the semicircle grooves; the two bolts drill through the two through holes of the inner cover board to get into the two bolt holes of the main body of bakeware handle.

6. A handle for a baking tray, comprising
a raised ear fixedly connected to one side of the baking tray and extending outwards, wherein the raised ear has a short shaft;
a main body of the handle having tongue part which extends to the baking tray and is pin jointed with the short shaft; and
at least a torsional spring covering the short shaft, wherein one end of the torsional spring is set against the raised ear and the other end of the torsional spring is set against the main body.

7. The handle according to claim 6, wherein either of the two ends of the short shaft respectively has a torsional spring, and one end of each torsional spring is set against the raised ear and the other end of the torsional spring is set against the main body.

8. The handle according to claim 6, wherein the lower part of the main body has an inward hollow portion formed by a sidewall and a baffle, with a relief opening formed in the middle of the baffle; the lower surface of the inward hollow portion has two raised parts that extend downwards, and the two raised parts are respectively set at two sides of the relief opening; and wherein the raised ear is inserted into the inward hollow portion through the relief, and the two ends of the short shaft of the raised ear are pin jointed with the two raised parts.

9. The handle according to claim 8, wherein an inner cover board is installed under the main body to cover the inward hollow portion, the upper surface of the inner cover board has two upwardly-extending raised parts, which respectively correspond to two downwardly extending raised parts located on the inward hollow portion of the main body; and wherein the two upwardly-extending raised parts of the inner cover board and the two downwardly-extending raised parts of the main body comprises semicircle grooves at the opposing sides, and the semicircle grooves form pin jointed holes of the two ends of the short shaft of the raised ear.

10. The handle according to claim 9, wherein each raised part of the inner cover board comprises a through hole, and each raised part of the main body handle has a bolt hole corresponding with the through hole at the outer side of the semicircle grooves; and two bolts are placed through the two through holes of the inner cover board to get into the two bolt holes of the main body.

11. The handle according to claim 7, wherein the lower part of the main body has an inward hollow portion formed by a sidewall and a baffle, with a relief opening formed in the middle of the baffle; the lower surface of the inward hollow portion has two raised parts that extend downwards, and the two raised parts are respectively set at two sides of the relief opening; and wherein the raised ear is inserted into the inward hollow portion through the relief, and the two ends of the short shaft of the raised ear are pin jointed with the two raised parts.

12. The handle according to claim 11 wherein an inner cover board is installed under the main body to cover the inward hollow portion, the upper surface of the inner cover board has two upwardly-extending raised parts, which respectively correspond to two downwardly extending raised parts located on the inward hollow portion of the main body; and wherein the two upwardly-extending raised parts of the inner cover board and the two downwardly-extending raised parts of the main body comprises semicircle grooves at the opposing sides, and the semicircle grooves form pin jointed holes of the two ends of the short shaft of the raised ear.

13. The handle according to claim 12, wherein each raised part of the inner cover board comprises a through hole, and each raised part of the main body handle has a bolt hole corresponding with the through hole at the outer side of the semicircle grooves; and two bolts are placed through the two through holes of the inner cover board to get into the two bolt holes of the main body.
